(19) United States
(12) Patent Application Publication
(10) Pub. No.: US 2003/0173274 A1
(43) Pub. Date: Sep. 18, 2003

(54) Blood component separation device, system, and method including filtration

(76) Inventors: Frank Corbin III, Littleton, CO (US); Dennis Hlavinka, Arvada, CO (US)

Correspondence Address: Finnegan, Henderson, Farabow,, Garrett & Dunner, L.L.P., 1300 I Street, N.W., Washington, DC, 20005-3315, US

(21) Appl. No.: 10/356,605

(22) Filed: Feb. 3, 2003

Related U.S. Application Data
(60) Provisional application No. 60/353,320, filed on Feb. 1, 2002.

(51) Int. Cl. B01D 17/12

(52) U.S. Cl. 210/115; 210/512.1; 210/259; 494/1; 494/43

(57) ABSTRACT

A device, system, and method are provided for separating blood components. The device includes a separation vessel for placement in a retainer of a rotatable centrifuge rotor. The separation vessel includes an inlet end portion, an outlet end portion, and a flow path extending from the inlet end portion to the outlet end portion. Blood components to be separated are supplied to the vessel via an inlet port at the inlet end portion, and separated blood components are removed via one or more outlet ports at the outlet end portion. The device also includes a leukocyte reduction filter including a porous filtration medium configured to filter leukocytes from at least some of the separated blood components removed from the vessel.

This application claims the benefit of priority under 35 U.S.C. § 119(e) of U.S. provisional patent application No. 60/353,320, filed Feb. 1, 2002.

### BACKGROUND OF THE INVENTION

1. Field of the Invention

The present invention relates to a device, system and method for separating components of blood. In particular, the invention relates to separating blood components through the use of both centrifugal separation and filtration.

2. Description of the Related Art

Whole blood consists of various liquid components and particle components. The liquid portion of blood is largely made up of plasma, and the particle components include red blood cells (erythrocytes), white blood cells (leukocytes), and platelets (thrombocytes). While these constituents have similar densities, their average density relationship, in order of decreasing density, is as follows: red blood cells, white blood cells, platelets, and plasma. In terms of size, the particle constituents are related, in order of decreasing size, as follows: white blood cells, red blood cells, and platelets. Most current separation devices rely on density and size differences or surface chemistry characteristics to separate blood components.

Separation of certain blood components is often required for certain therapeutic treatments involving infusion of particular blood components into a patient. For example, in a number of treatments involving infusion of platelets, there is sometimes a desire to separate out at least some leukocytes before infusing a platelet-rich blood component collection into a patient.

For these and other reasons, there is a need to adopt approaches to separating components of blood.

### SUMMARY

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

In one aspect, the present invention includes a blood component separation device for use with a centrifuge having a rotatable rotor including a retainer. The device may include both a separation vessel for placement in the retainer and a leukocyte reduction filter. The vessel may include an inlet end portion, an outlet end portion, and a flow path extending from the inlet end portion to the outlet end portion. The inlet end portion may include an inlet port for supplying, to the vessel, blood components to be separated; and the outlet end portion may include one or more outlet ports for separated blood components. The leukocyte reduction filter may include a porous filtration medium configured to filter leukocytes from separated blood components removed from the vessel via the outlet port(s). The filter may also possibly filter other types of blood components (e.g., high density components, such as red blood cells) along with the leukocytes.

In another aspect, the outlet end portion may include at least a first outlet port, a second outlet port, and a third outlet port for removing the separated blood components from the vessel. The device may also include an inlet line fluidly coupled to the inlet port, as well as first, second, and third outlet lines fluidly coupled to the first, second, and third outlet ports, respectively. In such an arrangement, the leukocyte reduction filter may be associated with the first outlet line. Alternatively, the filter may be associated with one of the other lines.

In a further aspect, the outlet end portion may include a fourth outlet port, and the device may include a fourth outlet line fluidly coupled to the fourth outlet port.

In still another aspect, the device may include a barrier in the outlet end portion of the vessel for substantially blocking passage of at least one of the separated blood components. One or more of outlet ports (e.g., the first outlet port) may be between the barrier and the inlet end portion of the vessel to remove the blocked blood component(s). Such outlet port(s) may be in flow communication with the filter.

In an even further aspect, the outlet end portion of the vessel may include a first passage for at least a relatively low density blood component and a second passage for at least a relatively high density blood component, the barrier being between the first and second passages such that the first passage is closer than the second passage to an axis of rotation of the rotor when the vessel is placed in the retainer.

When the device includes a barrier, the barrier could be configured in many different forms. In a few embodiments, the barrier may be a skimmer dam extending across the outlet end portion.

In one other aspect, the filter may include a filter housing configured to be mounted to a rotor via a mount associated with the rotor so that the filter rotates along with the rotor about the rotor's axis of rotation.

In still another aspect, the filter may be closer than an interior of the separation vessel to the axis of rotation.

In yet another aspect, one of the outlet ports may be positioned to remove at least one relatively low density blood component from the vessel, and another of the outlet ports may be positioned to remove at least one relatively high density blood component from the vessel. In one embodiment, the outlet of the filter may be in flow communication with the port(s) positioned to remove at least one relatively low density blood component so as to mix the at least one low density blood component with filtered substance flowing from the filter outlet. In some embodiments, one of the outlet ports may be positioned to adjust an interface of separated blood components in the vessel.

The separation vessel could also be configured in a number of different forms. In a few embodiments, the separation vessel may include a generally annular channel. Although the separation vessel could be formed of any material, in some embodiments at least part of the separation vessel is formed of a semi-rigid material and/or a flexible material.

In another aspect, the invention may include a centrifugal separation system including the device in combination with a centrifuge rotor configured to be rotated about an axis of rotation, wherein the centrifuge rotor includes a retainer configured to retain the separation vessel. For example, the retainer may include a generally annular groove in the rotor.

In a further aspect, a mount may be associated with the rotor. The mount may be configured to mount the filter to the rotor so that the filter rotates along with the rotor about the axis of rotation.

Still another aspect of the invention relates to a method of separating blood components. The method includes providing the device; placing the separation vessel in a retainer of a rotatable centrifuge rotor; rotating the centrifuge rotor and the separation vessel about an axis of rotation of the centrifuge rotor; introducing blood components into the separation vessel, wherein the blood components form stratified layers in the separation vessel; removing at least some blood components from the separation vessel via at least one of outlet ports; and filtering the removed blood components with the filter so as to filter at least some leukocytes from the removed blood components.

The term “providing” is used in a broad sense, and refers to, but is not limited to, making available for use, manufacturing, enabling usage, giving, supplying, obtaining, getting a hold of, acquiring, purchasing, selling, distributing, possessing, making ready for use, forming and/or obtaining intermediate product(s), and/or placing in a position ready for use.

In another aspect, the rotating may include rotating the filter about the axis of rotation. In some exemplary methods, the filtering may occur during the rotation of the filter about the axis of rotation.

In a further aspect, a buffy coat layer of the blood components may be formed in the separation vessel, and the blood components removed via the outlet port(s) comprise platelets and leukocytes from the buffy coat layer.

In yet another aspect, the blood components removed via the outlet port(s) may be intermediate density blood components, and the method may further include removing plasma from the vessel and removing red blood cells from the vessel. In some exemplary methods, plasma removed from the vessel may be mixed with the filtered blood components.

In an even further aspect, the method may include controlling position of an interface between high and intermediate density blood components, wherein the controlling of the interface position includes removing high and low density blood components from the separation vessel via an interface positioning port.

In one more aspect, the method may include accumulating at least intermediate density blood components with a barrier in the separation vessel, the accumulated intermediate density blood components being removed from the separation vessel via the outlet port(s). In some examples, the method may also include flowing plasma past the barrier (e.g., via the first passage) and flowing red blood cells past the barrier (e.g., via the second passage).

Aside from the structural and procedural arrangements set forth above, the invention could include a number of other arrangements such as those explained hereinafter. It is to be understood that both the foregoing description and the following description are exemplary only.

### BRIEF DESCRIPTION OF THE DRAWINGS

The accompanying drawings are incorporated in and constitute a part of this specification. The drawings illustrate exemplary embodiments and, together with the description, serve to explain some principles of the invention. In the drawings,

FIG. 1 is a partial perspective view of a centrifugal separation system including a filter in accordance with an embodiment of the invention;

FIG. 2 is a schematic, partial cross-section view of a portion of a blood component separation device for in the system of FIG. 1;

FIG. 3 is a perspective view of another embodiment of a blood component separation device;

FIG. 4 shows a portion of the device of FIG. 3 in a view similar to that of FIG. 2; and

FIG. 5 is a view similar to FIG. 4 of another alternative embodiment.

### DESCRIPTION OF A FEW EXEMPLARY EMBODIMENTS

Reference will now be made in detail to exemplary embodiments of the invention. Wherever possible, the same reference numbers are used in the drawings and the description to refer to the same or like parts, and the same reference numerals with alphabetical suffixes are used to refer to similar parts.

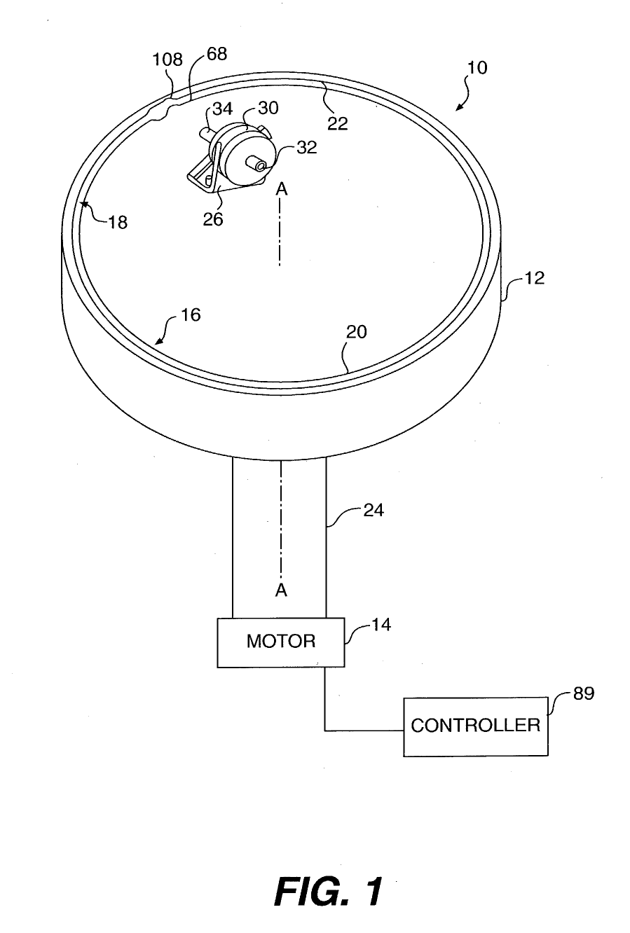

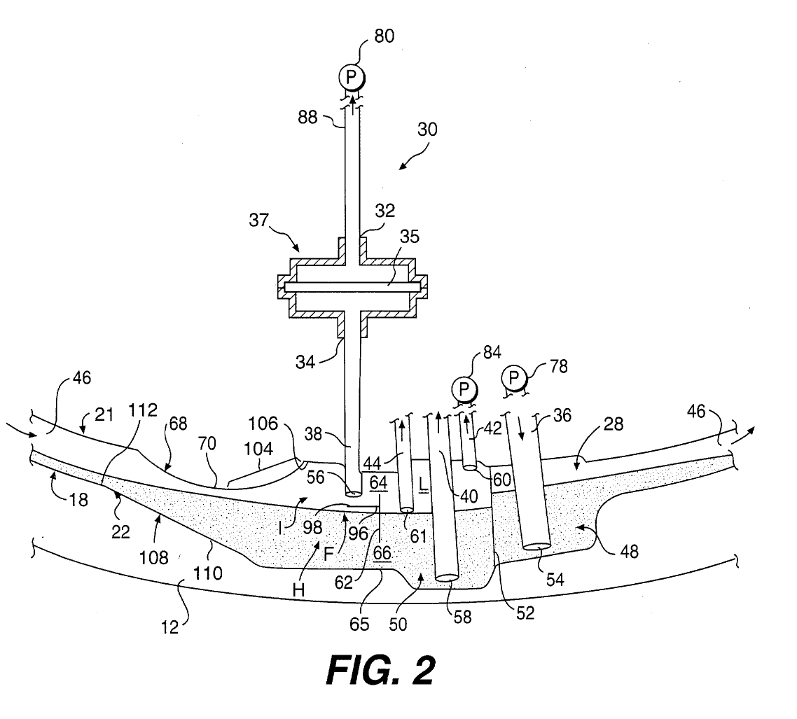

As shown in FIG. 1, one embodiment of system 10 includes a centrifuge rotor 12 coupled to a motor 14 so that the centrifuge rotor 12 rotates about its axis of rotation A-A. The rotor 12 has a retainer 16 including a passageway in the form of an annular groove 18 having an open upper surface adapted to receive a separation vessel 28, 28a, or 28b shown respectively in FIGS. 2, 3-4, and 5. The groove 18 completely surrounds the rotor's axis of rotation A-A and is bounded by an inner wall 20 and an outer wall 22 spaced apart from one another to define the groove 18 therebetween. Although the groove 18 shown in FIG. 1 completely surrounds the axis of rotation A-A, the groove could be partially around the axis A-A when the separation vessel is not generally annular.

As described in more detail in U.S. Pat. No. 6,334,842, a substantial portion of the groove 18 may have a constant radius of curvature about the axis of rotation A-A and be positioned at a maximum possible radial distance on the rotor 12 so that blood components separated in the separation vessel 28, 28a, 28b undergo relatively constant centrifugal forces as they pass from an inlet portion to an outlet portion of the separation vessel 28, 28a, 28b.

The motor 14 is coupled to the rotor 12 directly or indirectly through a shaft 24 connected to the rotor 12. Alternately, the shaft 24 may be coupled to the motor 14 through a gearing transmission (not shown).

As shown in FIG. 1, a mount 26 is coupled to a top surface of the rotor 12. The mount 26 is configured to mount a leukocyte reduction filter 30 to the rotor 12 so that the filter 30 rotates along with the rotor 12 about the axis of rotation A-A. The mounting of the filter 30 in the mount 26 may be a releasable mounting so as to permit the filter 30 to be mounted and, thereafter, un-mounted and replaced with another filter 30. The filter 30 may include a filter housing 37 having a shape that is configured to permit mounting of the filter 30 to the mount 26 via a sliding motion of the filter 30 into an open top of the mount 26. Many alternative forms of mounting arrangements are also possible.

The mount 26 may be oriented to enable mounting of the filter 30 on the rotor 12 so that an outlet 32 of the filter 30 is positioned closer than an inlet 34 of the filter 30 to the axis of rotation A-A. (Alternatively, the orientation of the filter may be arranged such that the filter inlet is positioned closer to the axis of rotation than the filter outlet.) For example, the mount 26 may orient the filter 30 on the rotor 12 so that an axis of the filter 30 is generally in a plane transverse to the rotor's axis of rotation A-A. Alternatively, the filter 30 could be mounted so that the axis of the filter 30 is. substantially parallel to the rotor's axis of rotation A-A. In another alternative arrangement, the axis of rotation could intersect the filter and the axis of the filter could be in any orientation (e.g., tin the middle of the rotor). Although the mount 26 shown in FIG. 1 mounts the filter 30 on a top surface of the rotor 12, there are many possible alternative locations where the filter 30 could be mounted. For example, the filter 30 may also be mounted to the rotor 12 at alternative locations, such as beneath the top surface of the rotor 12. To reduce forces encountered by the filter 30, the filter 30 may be positioned closer than an interior of the separation vessel to the rotor's axis of rotation A-A, but the filter could alternatively be positioned at other locations. In some alternative embodiments (not shown), the filter 30 could be located out of the centrifugal field generated during rotation of the rotor 12, so that the filter 30 would not rotate along with the rotor 12.

FIG. 2 schematically illustrates a portion of the separation vessel 28 and the filter 30 mounted on the rotor 12. The separation vessel 28 has a generally annular flow path 46 and includes an inlet end portion 48 and outlet end portion 50. A wall 52 prevents substances from passing directly between the inlet and outlet end portions 48 and 50 without first flowing around the generally annular flow path 46 (e.g., counter-clockwise as illustrated by arrows in FIG. 2).

In the portion of the separation vessel 28 between the inlet and outlet end portions 48 and 50, a radial outer wall 65 of the separation vessel 28 is positioned closer to the axis of rotation A-A than the radial outer wall 65 in the outlet portion 50. During separation of blood components in the separation vessel 28, this arrangement causes formation of a very thin and rapidly advancing red blood cell bed in the separation vessel 28 between the inlet and outlet end portions 48 and 50.

As shown in FIG. 2, the inlet end portion 48 includes an inflow tube 36 for conveying blood components into the separation vessel 28. The outlet end portion 50, on the other hand, includes first, second, and third outlet lines 38, 40, 42 for removing separated substances from the separation vessel 28 and an interface control line 44 for adjusting the level of an interface F between separated blood components in the vessel 28. The separation vessel 28 may form what is known as a single stage component separation area (in contrast to an arrangement having a plurality of such stages). In other words, each of the components separated in the vessel 28 may be collected and removed in only one area of the vessel 28, namely the outlet end portion 50. In addition, the separation vessel 28 may include a substantially constant radius except in the region of the outlet end portion 50 where the outer wall of the outlet portion 50 may be positioned farther away from the axis of rotation A-A to allow for outlet ports 56, 58, 60, and 61 of the lines 38, 40, 42, and 44, respectively, to be positioned at different radial distances and to create a collection pool with greater depth for high density red blood cells.

The blood components removed through the lines 38, 40, and 42 can be either collected or reinfused back into a donor. In some embodiments (not shown), one or more of the lines 40, 42, and 44 could be omitted.

Although FIG. 2 shows the inlet end portion 48 as having a wide radial cross-section, the outer wall of the inlet portion 48 can be spaced closer to the inner wall of the inlet portion 48 and/or be tapered. An inlet port 54 of inflow tube 36 allows for flow of blood components to be separated into the inlet end portion 48 of separation vessel 28. During a separation procedure, blood components entering the inlet portion 48 follow the flow path 46 and stratify according to differences in density in response to rotation of the rotor 12. The flow path 46 between the inlet and outlet portions 48 and 50 may be curved and have a substantially constant radius. In addition, the flow path 46 may be placed at the maximum distance from the axis A-A. This shape ensures that blood components passing through the flow path 46 encounter a relatively constant gravitational field and a maximum possible gravitational field for the rotor 12.

The separated blood components flow into the outlet portion 50 where they are removed via first, second, and third outlet ports 56, 58, and 60 respectively, of first, second, and third outlet lines 38, 40, and 42. Separated blood components are also removed by an interface controlling outlet port 61 of the interface control line 44.

As shown in FIG. 2, the first, second, and third ports 56, 58, and 60 and interface port 61 are positioned at varying radial locations on the rotor 12 to remove blood components having varying densities. The second outlet port 58 is farther from the axis of rotation A-A than the first, third, and interface ports 56, 60 and 61 to remove higher density components H separated in the separation vessel 28, such as red blood cells. The third port 60 is located closer to the axis of rotation A-A than the first, second, and interface ports 56, 58, and 61 to remove the least dense components L separated in the separation vessel 28, such as plasma. In one exemplary arrangement, the first port 56 may be about 0.035 inch to about 0.115 inch closer than the interface port 61 to the axis of rotation A-A.

As shown in FIG. 2, the outlet end portion 50 includes a barrier 62 configured to substantially block flow of intermediate density components 1, such as platelets and some leukocytes. The barrier 62 may be a skimmer dam extending completely across the outlet portion 50 in a direction generally parallel to the axis of rotation A-A. The first outlet port 56 is positioned immediately upstream from barrier 62, downstream from the inlet portion 48, to collect at least the intermediate density components I blocked by the barrier 62 and, optionally, some of the lower density components L.

Radially inner and outer edges of the barrier 62 are spaced from radially inner and outer walls 63, 65 of the separation vessel 28 to form a first passage 64 for lower density components L, such as plasma, at a radially inner position in the outlet portion 50 and a second passage 66 for higher density components H, such as red blood cells, at a radially outer position in the outlet portion 50. The second and third outlet ports 58 and 60 may be positioned downstream from the barrier 62 to collect the respective high and low density components H and L passing through the second and first passages 66 and 64.

The interface control outlet port 61 also may be positioned downstream from the barrier 62. During a separation procedure, the interface port 61 removes the higher density components H and/or the lower density components L in the outlet portion 50 to thereby control the radial position of the interface F between the intermediate density components I and higher density components H in the outlet portion 50 so that the interface F and the interface port 61 are at about the same radial distance from the rotational axis A-A.

Arrangements other than the interface port 61 may be used to control the radial position of the interface F. For example, the position of the interface F could be controlled without using an interface port by providing an optical monitor (not shown) for monitoring the position of the interface and controlling flow of liquid and/or particles through one or more of the ports 54, 56, 58, and 60 in response to the monitored position.

The second outlet line 40 may be flow connected to the interface control line 44 so that substances removed via the second outlet port 58 and the interface control port 61 are combined and removed together through a common line. Although the second and third outlet ports 58 and 60 and the interface outlet port 61 are shown downstream from the barrier 62, one or more of these ports may be upstream from the barrier 62. In addition, the order of the outlet ports 56, 58, 60, and the control port 61 along the length of the outlet portion 50 could be changed.

A shield 96 is positioned between the first outlet port 56 and the outer wall 65 to limit entry into the first outlet port 56 of the higher density components H. The shield 96 may be a shelf extending from an upstream side of the dam 62. For example, the shield 96 may be at least as wide (in a direction parallel to the axis A-A) as the first outlet port 56 and extend upstream at least as far as the upstream end of first outlet port 56 so that the shield 96 limits direct flow into the first outlet port 56 of components residing between the shield 96 and the outer wall 65, including the higher density components H. In other words, the shield 96 may ensure that a substantial amount of the substances flowing into the first outlet port 56 originate from radial locations which are not further than the shield 96 from the axis of rotation A-A.

As described in more detail in U.S. Pat. No. 6,334,842, the shield 96 has a radially inner surface 98 facing the first outlet port 56. For example, the inner surface 98 may be spaced radially outward from the first outlet port 56 by a distance of from about 0.005 inch to about 0.08 inch. In another example, that distance may be from about 0.02 inch to about 0.03 inch. The inner surface 98 is positioned farther than the first and third outlet ports 56 and 60 from the axis of rotation A-A. The inner surface 98 is also positioned closer than the second outlet port 58 and the interface outlet port 61 to the axis of rotation A-A.

As shown in FIGS. 1 and 2, a ridge 68 may extend from the inner wall 20 of the groove 18 toward the outer wall 22 of the groove 18. When the separation vessel 28 shown in FIG. 2 is loaded in the groove 18, the ridge 68 deforms semi-rigid or flexible material in the outlet portion 50 of the separation vessel 28 to form a trap dam 70 on the radially inner wall 63 of the separation vessel 28, upstream from the first outlet port 56. The trap dam 70 extends away from the axis of rotation A-A to trap a portion of lower density substances, such as priming fluid and/or plasma, along a radially inner portion of the separation vessel 28 located upstream the trap dam 70.

When the separation vessel 28 is used to separate whole blood into blood components, the trap dam 70 traps priming fluid (i.e. saline) and/or plasma along the inner wall 63 and these trapped substances help convey platelets to the outlet portion 50 and first outlet port 56 by increasing plasma flow velocities next to the layer of red blood cells in the separation vessel 28 to scrub platelets toward the outlet portion 50. The trapped priming fluid and/or plasma along the inner wall 63 may also substantially limit, or even prevent, platelets from contacting the radial inner wall 63.

The trap dam 70 may have a relatively smooth surface to limit disruption of flow in the separation vessel 28, for example, by reducing Coriolis forces. For example, a downstream portion 104 of the trap dam 70 has a relatively gradual slope extending in the downstream direction toward the axis of rotation A-A. During a blood component separation procedure, the relatively gradual slope of the downstream portion 104 limits the number of platelets (intermediate density components) that become reentrained (mixed) with plasma (lower density components) as plasma flows along the trap dam 70. In addition, the gradual sloped shape of the downstream portion 104 reduces the number of platelets that accumulate in the separation vessel 28 before reaching the first outlet port 56.

As shown in FIG. 2, the gradual slope of the downstream portion 104 may extend to a downstream end 106 located closer than the first outlet port 56 to the axis of rotation A-A. When the separation vessel 28 is used for blood component separation, the downstream end 106 may be located radially inward from the layer of platelets formed in the separation vessel 28. In contrast, when the downstream end 106 is located radially outward from the radially innermost portion of the platelet layer, plasma flowing along the surface of the dam 70 could reentrain (mix) the platelets in plasma downstream from the dam, reducing the efficiency of blood component separation.

In the embodiment shown in FIG. 2, the trap dam 70 and its downstream portion 104 may have a generally convex curvature. For example, the surface of the trap dam 70 may be in the form of a constant radius arc having a center of curvature offset from the axis of rotation A-A. Although the trap dam 70 could have any radius of curvature, one exemplary radius may be in a range of from about 0.25 inch to about 2 inches, and another exemplary radius may be about 2 inches.

Although the embodiment of FIG. 2 includes the ridge 68 that deforms the separation vessel 28 to form the trap dam 70, the trap dam 70 could be formed in other ways. For example, the trap dam 70 could be a permanent structure extending from a radially inner wall of the separation vessel 28. In addition, the trap dam 70 could be positioned closer to the barrier 62 and have a small hole passing therethrough to allow for passage of air in a radial inner area of the outlet portion 50.

As shown in FIGS. 1 and 2, the outer wall 22 of the groove 18 may include a gradual sloped portion 108 facing the ridge 68 in the inner wall 20. When the separation vessel 28 shown in FIG. 2 is loaded in the groove 18, the gradual sloped portion 108 deforms semi-rigid or flexible material in the outlet portion 50 of the separation vessel 28 to form a relatively smooth and gradual sloped segment 110 in a region of the vessel 28 across from the trap dam 70. In an alternative embodiment, this gradual sloped segment 110 is a permanent structure formed in the separation vessel 28.

In the downstream direction, the segment 110 slopes gradually away from the axis of rotation A-A to increase the thickness of a layer of high density fluid components H, such as red blood cells, formed across from the trap dam 70. The gradual slope of the segment 110 maintains relatively smooth flow transitions in the separation vessel 28 and reduces the velocity of high density components H (red blood cells) formed radially outward from the intermediate density components I (platelets).

An upstream end 112 of the gradual sloped segment 110 may be positioned upstream from the trap dam 70. This position of the upstream end 112 reduces the velocity of high density components H, such as red blood cells, as these components flow past the trap dam 70 and form radially outward from the layer of intermediate density components I blocked by the barrier 62.

Further details concerning the structure and operation of the separation vessel 28 are described in above-mentioned U.S. Pat. No. 6,334,842.

As shown in FIG. 2, the first outlet line 38 is connected between the first outlet port 56 and the filter inlet 34 to pass the intermediate density components into the filter 30. Blood components initially separated in the separation vessel 28 are passed into the filter 30 to filter at least some leukocytes. For example, leukocytes could be filtered from plasma and platelets in the filter 30. In some embodiments, high density components, such as red blood cells, may also be filtered by the filter 30 and/or certain subsets of leukocytes (e.g., granulocytes) may be filtered from other subsets of leukocytes via the filter 30.

The filter 30 could be configured in the form of any known filter capable of filtering at least some leukocytes from blood components. Just a few examples of such filters include filters sold under the following trade names: “r\LS” manufactured by HemaSure, Inc., located in Marlborough, Mass.; “Sepacell” from Asahi Corp and/or Baxter, Inc.; and/or “RC 100”, “RC50” and “BPF4”, etc., from Pall Corp., located in Glencove, N.Y. As shown in FIG. 2, the filter 30 may include a porous filtration medium 35 configured to filter at least some leukocytes. The medium 35 may be housed completely within the filter housing 37. The filtration medium 35 could be any form of porous medium used to filter leukocytes. For example, the medium could include fibers combined together in a woven or unwoven form, loose fibers, and/or one or more membranes.

When the filter 30 is mounted on the rotor 12, as shown in FIG. 1, and intended to be used for filtering of leukocytes during rotation of the rotor 12, the filter 30 has a construction that allows for the filtering to take place in the centrifugal field generated by the rotor's rotation.

As schematically shown in FIG. 2, a plurality of pumps 78, 80, 84 are provided for adding and removing substances to and from the separation vessel 28 and filter 30. An inflow pump 78 is coupled to the inflow line 36 to supply a substance to be separated, such as whole blood, to the inlet portion 48. A first pump 80 is coupled to outflow tubing 88 connected to the filter outlet 32. The first pump 80 draws blood components from the filter outlet 32 and causes blood components to enter the filter 30 via the filter inlet 34.

A second pump 84 is flow coupled to the second outlet line 42 for removing substances through the third outlet port 60. As shown in FIG. 2, the second outlet line 40 and interface control line 44 may be flow connected together, and blood components may flow through these lines 40 and 44 as a result of positive fluid pressure in the vessel outlet portion 50.

The pumps 78, 80, 84 may be peristaltic pumps or impeller pumps configured to prevent significant damage to blood components. However, any fluid pumping or drawing device may be provided. (Alternatively, one or more of the pumps may be omitted and one or more of the blood components could be pushed through the filter via the flow of downstream components.) In an alternative embodiment (not shown), the first pump 80 may be fluidly connected to the filter inlet 34 to directly move substances into and through the filter 30. The pumps 78, 80, 84 may be mounted at any convenient location.

As shown in FIG. 1, the apparatus 10 further includes a controller 89 connected to the motor 14 to control rotational speed of the rotor 12. In addition, the controller 89 may be operatively connected to the pumps 78, 80, 84 to control the flow rate of substances flowing to and from the separation vessel 28 and the filter 30. The controller 89 may include a computer having programmed instructions provided by a ROM or RAM as is commonly known in the art.

The controller 89 may vary the rotational speed of the centrifuge rotor 12 by regulating frequency, current, or voltage of the electricity applied to the motor 14. Alternatively, the rotational speed may be varied by shifting the arrangement of a transmission (not shown), such as by changing gearing to alter a rotational coupling between the motor 14 and rotor 12. The controller 89 may receive input from a rotational speed detector (not shown) to constantly monitor the rotation speed of the rotor 12.

The controller 89 may also regulate one or more of the pumps 78, 80, 84 to vary the flow rates for substances supplied to or removed from the separation vessel 28 and the filter 30. For example, the controller 89 may vary the electricity provided to the pumps 78, 80, 84. Alternatively the controller 89 may vary the flow rate to and from the vessel 28 and the filter 30 by regulating valving structures (not shown) associated with the lines 36, 38, 40, 42, 44 and/or 88.

The controller 89 may be configured to control flow so that blood components continue to be separated in the separation vessel 28a while the separated blood components are passed into the filter 30 for filtering of at least some leukocytes, so as to filter the leukocytes in a form of “on-line” process. Alternatively (or additionally), the controller 89 may be configured so that filtering via the filter 30 takes place at least some time after at least an initial separation of blood components in the separation vessel 28. Furthermore, when the filter 30 is mounted to the rotor 12, the controller 89 may be configured to control flow so that leukocytes are filtered in the filter 30 during the rotation of the rotor 12. In some alternative embodiments, the controller 89 may be configured to control both the flow and rotor rotation so that at least part of the leukocyte filtration occurs after the rotor 12 has slowed its rotational speed (or even stopped rotating) after reaching a rotational speed used to stratify blood components.

The controller 89 may receive input from a flow detector (not shown) positioned within the first outlet line 38 to monitor the flow rate of substances entering the filter 30. Although a single controller 89 having multiple operations is schematically depicted in the embodiment shown in FIG. 1, the controlling structure of the of the illustrated embodiment may include any number of individual controllers, each for performing a single function or a number of functions. The controller 89 may control flow rates in many other ways as is known in the art.

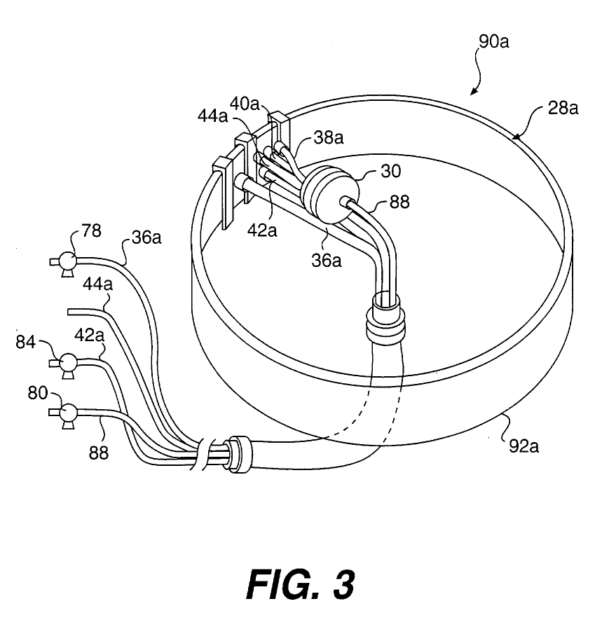

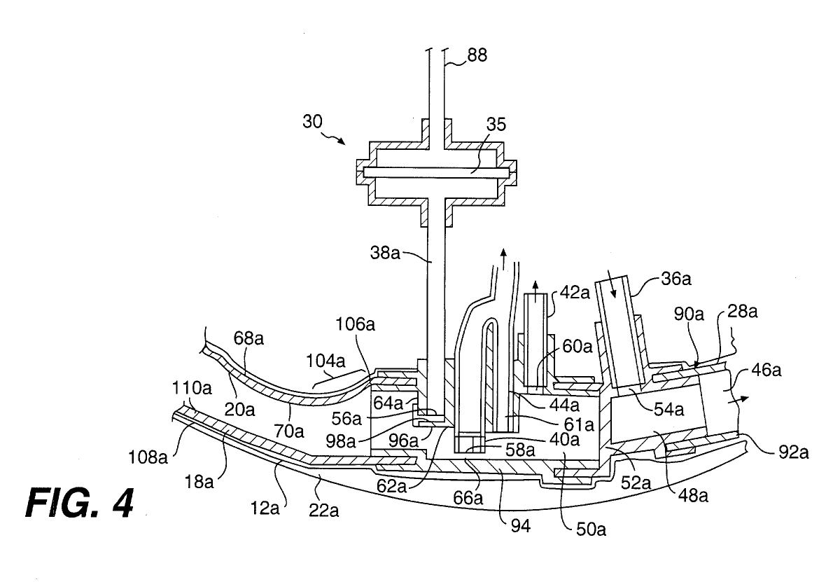

FIG. 3 shows an embodiment of a device 90a for use in the system 10, and FIG. 4 illustrates a cross-sectional view of a portion of the device 90a mounted in groove 18a on rotor 12a. The device 90a includes a separation vessel 28a, the filter 30, an inflow tube 36a for conveying blood components to be separated, such as whole blood, into the separation vessel 28a, first, second, and third outlet lines 38a, 40a, 42a for removing separated blood components from the separation vessel 28a, and an interface control line 44a for adjusting the level of an interface between separated blood components in the vessel 28a. When the separation vessel 28a is mounted on a rotor 12a, the lines 36a, 38a, 42a, and 44a may pass through slots (not shown) formed on the rotor 12a.

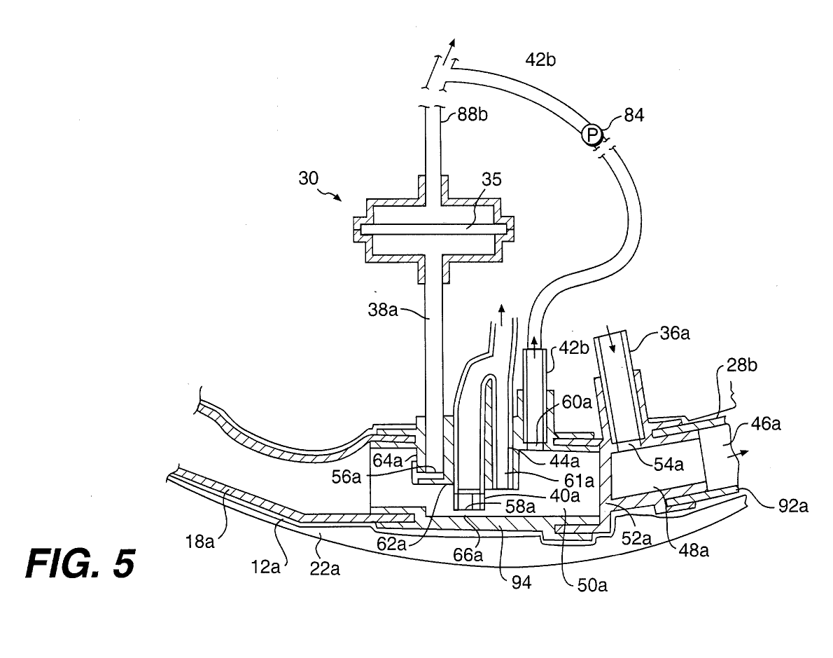

The separation vessel 28a may include a generally annular channel 92a formed of semi-rigid or flexible material and having a flow path 46a, shown in FIG. 4. Opposite ends of the channel 92a are connected to a relatively rigid connecting structure 94 including an inlet end portion 48a and outlet end portion 50a for the separation vessel 28a separated by a wall 52a. An inlet port 54a of inflow tubing 36a is in fluid communication with the inlet end portion 48a and allows for flow of blood components into the separation vessel 28a. During a separation procedure, blood components entering the vessel 28a via the inlet port 54a flow around the channel 92a (counter-clockwise in FIG. 5) via the flow path 46a and stratify according to differences in density in response to rotation of the rotor 12a.

The separated blood components flow into the outlet portion 50a where they are removed through first, second and third outlet ports 56a, 58a, and 60a of respective first, second, and third outlet lines 38a, 40a, and 42a and an interface control port 61a of the interface control line 44a. As shown in FIG. 4, the second outlet line 40a may be connected to the interface control line 44a so that substances flowing through the second outlet line 40a and interface control line 44a are removed together through a portion of the interface control line 44a.

The first, second and third outlet ports 56a, 58a, and 60a and the interface control port 61a have the same relative radial positioning as that of the first, second, and third outlet ports 56, 58, and 60 and the interface control port 61 shown in FIG. 2, respectively. The first port 56a and interface port 61a may be spaced in the radial direction by a distance of from about 0.035 inch to about 0.115 inch so that the first port 56a is slightly closer to the rotor's axis of rotation.

The outlet portion 50a includes a barrier 62a for substantially blocking flow of intermediate density substances, such as platelets and some lekocytes. In the embodiment shown in FIG. 4, the barrier 62a is a skimmer dam extending across the outlet portion 50a in a direction generally parallel to the axis of rotation A-A. The first outlet port 56a is positioned immediately upstream from the skimmer dam 62a, and downstream from the inlet portion 48a, to collect the intermediate density substances blocked by the skimmer dam 62a.

A shield 96a extends from the upstream side of the skimmer dam 62a. The shield 96a may be configured like the shield 96 shown in FIG. 2 to limit flow of higher density components into the first port 56a. For example, the radially inward surface 98a of the shield 96a may be spaced radially outward from the first outlet port 56a by a gap of from about 0.005 inch to about 0.08 inch. In another example, the gap may be from about 0.02 inch to about 0.03 inch.

Radially inner and outer edges of the skimmer dam 62a are spaced from radially inner and outer walls of the separation vessel 28a to form a first passage 64a for lower density substances, such as plasma, at a radially inner position in the outlet portion 50a and a second passage 66a for higher density substances, such as red blood cells, at a radially outer position in the outlet portion 50a. The second and third outlet ports 58a and 60a may be positioned downstream from the skimmer dam 62a to collect the respective higher and lower density substances passing through the first and second passages 66a and 64a.

As shown in FIG. 4, a ridge 68a extends from the inner wall 20a of the groove 18a toward the outer wall 22a of the groove 18a. When the separation vessel 28a is loaded in the groove 18a, the ridge 68a deforms the semi-rigid or flexible material of the separation vessel 28a to form a trap dam 70a on the radially inner wall of the separation vessel 28a between the first outlet port 56a and the inlet portion of the separation vessel 28a. The trap dam 70a extends away from the axis of rotation A-A to trap a portion of lower density substances, such as priming fluid and/or plasma, along a radially inner portion of the separation vessel 28a. In addition, the trap dam 70a has a gradual sloped downstream portion 104a, and a downstream end 106a located closer than the first outlet port 56a to the axis of rotation A-A. The trap dam 70a may have the same or substantially the same structural configuration and function as the trap dam 70 shown in FIG. 2 and could be permanent structure formed in the vessel 28a.

The outer wall 22a may include a gradual sloped portion 108a for forming a corresponding gradual sloped segment 110a in the vessel 28a when the vessel 28a is deformed in the groove 18. The portion 108a and segment 110a have the same or substantially the same structural configuration and function as the portion 108 and segment 110 shown in FIG. 2, respectively.

FIG. 5 shows an embodiment of a separation vessel 28b constructed substantially the same as the separation vessel 28a shown in FIGS. 3-4. In this embodiment, the third outlet line 42b is flow coupled to the outflow tubing 88b extending from the filter outlet 32. This places the third outlet port 60a in flow communication with the filter outlet 32 to thereby mix substances flowing through the third outlet port 60a with substances flowing through the filter outlet 32. During a blood component separation procedure, for example, this structural configuration mixes plasma flowing through third port 60a with platelets and plasma flowing from the filter 30. In certain circumstances, this dilution of the platelet collection may be desired to possibly increase shelf life of the platelet collection.

The filter outlet 32 and third outlet port 60a could be flow coupled in many different ways. For example, the third outlet line 42b could coupled to the outflow tubing 88b upstream from pump 80 shown in FIG. 2 to reduce the concentration of particles being pumped and possibly eliminate pump 84. In the alternative, the outlet of pump 84 could be flow coupled to the outlet of pump 80, for example. In some examples, the flow connection of the third outlet line 42b and outflow tubing 88b is not located on the rotatable centrifuge rotor 12a.

A number of different modifications of the illustrated structure are possible. For example, the above-mentioned separation vessels 28, 28a, and 28b may be generally belt shaped and have the inlet portion and outlet portion in separate ends spaced from one another without having the inlet end portion connected directly to the outlet end portion to form a generally annular shape.

The embodiments shown in the drawings may be used in conjunction with a COBE® SPECTRA™ single stage blood component centrifuge. The COBE® SPECTRA™ centrifuge incorporates a one-omega/two-omega seal-less tubing connection as disclosed in U.S. Pat. No. 4,425,112. The COBE® SPECTRA™ centrifuge also uses a single-stage blood component separation channel having certain features disclosed in U.S. Pat. No. 4,094,461 and U.S. Pat. No. 4,647,279. The embodiments shown in the drawings are described in combination with the COBE® SPECTRA™ centrifuge for purposes of discussion only, and this is not intended to limit the invention in any sense. For example, more than one stage may be used, such as a dual stage separator.

As will be apparent to one having skill in the art, embodiments of the present invention may be configured in many different forms other than those shown in the drawings. In particular, a variety of different embodiments are possible for use in many different types of centrifuges capable of being used to separate blood components. For example, some embodiments may be configured to be used with a centrifugal apparatus that employs a component collect line such as a platelet collect line or a platelet rich plasma line, regardless of whether there is a single stage channel and/or a one-omega/two-omega seal-less tubing connection.

Methods of separating components of blood are discussed below with reference to FIGS. 1, 2, and 5. Although the methods are described in connection with the structure shown in the drawings, it should be understood that the invention in its broadest sense is not so limited. In particular, the structure used to practice the invention could be different from that shown in the drawings. In addition the methods could be practiced in conjunction with both double needle and single needle blood purification or filtration applications.

After placing the separation vessel 28 in the retainer 16 and mounting the filter 30 in the mount 26, the separation vessel 28 and filter 30 may be initially primed with a low density fluid medium, such as air, saline solution, plasma, or another fluid substance having a density less than or equal to the density of liquid plasma. Alternatively, the priming fluid is whole blood itself. When saline solution is used, the pump 78 shown in FIG. 2 pumps this priming fluid through the inflow line 36 and into the separation vessel 28 via the inlet port 54. The saline solution flows from the inlet portion 48 to the outlet portion 50 (counter-clockwise in FIG. 2) and through the filter 30 when the controller 89 activates the pump 80. Controller 89 also initiates operation of the motor 14 to rotate the centrifuge rotor 12, separation vessel 28, and filter 30 about the axis of rotation A-A.

As the separation vessel 28 rotates, a portion of the priming fluid (blood or saline solution) becomes trapped upstream from the trap dam 70 and forms a dome of priming fluid (plasma or saline solution) along an inner wall of the separation vessel 28 upstream from the trap dam 70. After the apparatus 10 is primed, and as the rotor 10 rotates, blood components (e.g., whole blood or blood components separated from whole blood) are introduced through the inlet port 54 into the separation vessel 28. The blood components may be added to the separation vessel 28 by transferring the blood components directly from a donor through inflow line 36. In the alternative, the blood components may be transferred from a container, such as a blood bag, to inflow line 36.

The blood components within the separation vessel 28 are subjected to centrifugal force causing the components to separate. The components of blood stratify in order of decreasing density as follows: 1. red blood cells, 2. white blood cells, 3. platelets, and 4. plasma. The controller 89 regulates the rotational speed of the centrifuge rotor 12 to ensure that this particle stratification takes place. A layer of red blood cells (high density component(s) H) forms along the outer wall of the separation vessel 28 and a layer of plasma (lower density component(s) L) forms along the inner wall of the separation vessel 28. Between these two layers, the intermediate density platelets and leukocytes (intermediate density components 1) form a buffy coat layer. This separation takes place while the components flow from the inlet end portion 48 to the outlet end portion 50. The radius of the flow path 46 between the inlet and outlet end portions 48 and 50 may be substantially constant to maintain a steady red blood cell bed in the outlet portion 50 even if flow changes occur.

In the outlet end portion 50, platelet poor plasma flows through the first passage 64 and downstream of the barrier 62 where it is removed via the third outlet port 60. Red blood cells flow through the second passage 66 and downstream of the barrier 62 where they are removed via the second outlet port 58. After the red blood cells and plasma are thus removed, they may be collected and recombined with other blood components or further separated. Alternately, these removed blood components may be reinfused into a donor.

The higher density component(s) H (red blood cells) and lower density component(s) L (plasma) are alternately removed via the interface control port 61 to control the radial position of the interface F between the higher density component(s) H and intermediate density component(s) I (buffy layer). This interface control may maintain the radially inner shield surface 98 between the interface F and first outlet port 56.

A substantial portion of the platelets and some of the leukocytes accumulate in a buffy coat layer upstream from the barrier 62. The accumulated platelets are removed via the first outlet port 56 along with some of the white blood cells and plasma. The shield 96 limits passage of higher density substances H (red blood cells) into the first outlet port 56. The shield 96 may reduce the number of red blood cells entering the first outlet port 56, thereby improving collection purity.

As the platelets, plasma, leukocytes, and possibly a small number of red blood cells pass through the first outlet port 56, these components flow into the filter 30. The porous filtration medium 35 may filter a substantial number of the leukocytes (and possibly also red blood cells that may have entered the filter 30). The filtered blood components including primarily platelets and plasma then flow from the filter 30 via the filter outlet 32.

The portion (e.g., dome) of priming fluid (i.e. saline) trapped along the inner wall of the separation vessel 28 upstream from the trap dam 70 guides platelets so that they flow toward the barrier 62 and the first outlet port 56. The trapped fluid reduces the effective passageway volume and area in the separation vessel 28 and thereby decreases the amount of blood initially required to prime the system in a separation process. The reduced volume and area also induces higher plasma and platelet velocities next to the stratified layer of red blood cells, in particular, to “scrub” platelets, toward the barrier 62 and first outlet port 56. The rapid conveyance of platelets may increase the efficiency of collection.

During a blood component separation procedure, the priming fluid trapped upstream from the trap dam 70 may eventually be replaced by other fluids such as low density, platelet poor plasma flowing in the separation vessel 28. Even when this replacement occurs, a dome or portion of trapped fluid may still maintained upstream from the trap dam 70.

The relatively gradual slope of the downstream portion 104 of the trap dam 70 limits the number of platelets that become reentrained with plasma as plasma flows along the trap dam 70. The downstream portion 104 also reduces the number of platelets accumulated upstream from the barrier 62.

The gradually sloped segment 110 causes formation of a layer of red blood cells across from the trap dam 70. The segment 110 maintains relatively smooth flow transitions in the separation vessel 28 and reduces the velocity of red blood cells in this region.

During a blood component separation procedure, a bed of red blood cells may be maintained along the radial outer wall 65 of the separation vessel 28 between the inlet and outlet portions 48 and 50. In addition, the dome or portion of fluid trapped by the trap dam 70 may be maintained along the radial inner wall 63 of the separation vessel 28.

Accumulated platelets, leukocytes, and some plasma and red blood cells, are removed via the first outlet port 56 and flow into the filter 30 where a substantial number of the leukocytes (and possibly also red blood cells) are filtered by the porous filtration medium 35. The controller 89 may regulate the pump 80 to convey at least the plasma, platelets, and leukocytes at a predetermined flow rate through the first outlet line 38 and into the inlet 34 of the filter 30 so as to limit the likelihood of overloading the filter 30 with too many blood components in a period of time.

The filter 30 filters a substantial number white blood cells from the blood components continuously entering the filter 30, while allowing at least plasma and platelets to exit the filter 30. Optionally, high density components, such as red blood cells, may also be filtered by the filter 30 and/or certain subsets of leukocytes (e.g., granulocytes) may be filtered from other subsets of leukocytes via the filter 30. After separation, the platelets and plasma exiting the filter 30 are collected in appropriate containers and stored for later use. The red blood cells and plasma removed from the vessel 28 may be combined for donor reinfusion or storage. Alternatively, these components may be further separated by the system 10.

If dilution of the platelet concentration is desired, the separation vessel 28b shown in FIG. 5 may be used to combine plasma removed via the third outlet port 60a with the platelets and plasma flowing from the filter outlet 32. This may allow for the dilution to take place rapidly without significant intervention by a procedurist.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A blood component separation device for use with a centrifuge having a rotatable rotor including a retainer, the device comprising:
a separation vessel for placement in the retainer, wherein the vessel comprises
an inlet end portion including an inlet port for supplying, to the vessel, blood components to be separated,
an outlet end portion comprising at least a first outlet port, a second outlet port, and a third outlet port for removing separated blood components from the vessel, and
a flow path extending from the inlet end portion to the outlet end portion;
an inlet line fluidly coupled to the inlet port;
a first outlet line fluidly coupled to the first outlet port;
a second outlet line fluidly coupled to the second outlet port;
a third outlet line fluidly coupled to the third outlet port; and
a leukocyte reduction filter associated with the first outlet line, the leukocyte reduction filter comprising a porous filtration medium configured to filter leukocytes from separated blood components removed from the vessel via the first outlet port.

2. The device of claim 1, wherein the filter further comprises a filter housing configured to be mounted to the rotor via a mount associated with the rotor so that the filter rotates along with the rotor about an axis of rotation of the rotor.

3. The device of claim 1, wherein the outlet end portion further comprises a fourth outlet port, wherein the device further comprises a fourth outlet line fluidly coupled to the fourth outlet port.

4. The device of claim 3, wherein one of the second, third, and fourth outlet ports is positioned to remove at least one relatively low density blood component from the vessel, and wherein another of the second, third, and fourth outlet ports is positioned to remove at least one relatively high density blood component from the vessel.

5. The device of claim 4, wherein an outlet of the filter is in flow communication with said one of the ports positioned to remove at least one relatively low density blood component so as to mix the at least one low density blood component with filtered substance flowing from the filter outlet.

6. The device of claim 3, wherein another of the second, third, and fourth outlet ports is positioned to adjust an interface of separated blood components in the vessel.

7. The device of claim 1, further comprising a barrier in the outlet end portion of the vessel for substantially blocking passage of at least one of the separated blood components, the first port being between the barrier and the inlet end portion of the vessel to remove the at least one blocked blood component.

8. The device of claim 7, wherein the outlet end portion of the vessel further comprises a first passage for at least a relatively low density blood component and a second passage for at least a relatively high density blood component, the barrier being between the first and second passages such that the first passage is closer than the second passage to an axis of rotation of the rotor when the vessel is placed in the retainer.

9. The device of claim 8, wherein the barrier is a skimmer dam extending across the outlet end portion.

10. The device of claim 1, wherein the separation vessel comprise a generally annular channel.

11. A centrifugal separation system comprising:
the device of claim 1; and
a centrifuge rotor configured to be rotated about an axis of rotation, wherein the centrifuge rotor comprises a retainer configured to retain the separation vessel.

12. The system of claim 11, further comprising a mount associated with the rotor, wherein the mount is configured to mount the filter to the rotor so that the filter rotates along with the rotor about the axis of rotation.

13. The system of claim 11, wherein the retainer comprises a generally annular groove in the rotor.

14. The system of claim 13, wherein the separation vessel comprise a generally annular channel configured to be placed in the groove.

15. The system of claim 14, wherein at least part of the separation vessel is formed of at least one of a semi-rigid material and a flexible material.

16. The system of claim 15, wherein the groove is defined by an inner wall spaced from the axis of rotation and an outer wall spaced farther from the axis of rotation than the inner wall, wherein the inner wall comprises a ridge extending toward the outer wall, the ridge deforming the separation vessel to form a trap dam in the separation vessel.

17. A blood component separation device for use with a centrifuge having a rotatable rotor including a retainer, the device comprising:
a separation vessel for placement in the retainer, wherein the vessel comprises
an inlet end portion including an inlet port for supplying, to the vessel, blood components to be separated,
an outlet end portion comprising
a barrier for substantially blocking passage of at least one separated blood component,
at least one outlet port between the barrier and the inlet end portion of the vessel for removing at least the at least one blocked blood component from the vessel,
a first passage for a relatively low density blood component, and
a second passage for a relatively high density blood component,
wherein the barrier is between the first and second passages, and
wherein the first passage is closer than the second passage to an axis of rotation of the rotor when the vessel is placed in the retainer, and
a flow path extending from the inlet end portion to the outlet end portion; and
a leukocyte reduction filter in flow communication with the at least one outlet port, the leukocyte reduction filter comprising a porous filtration medium configured to filter leukocytes from the at least one blocked blood component removed via the at least one outlet port.

18. The device of claim 17, wherein the filter further comprises a filter housing configured to be mounted to the rotor via a mount associated with the rotor so that the filter rotates along with the rotor about an axis of rotation of the rotor.

19. The device of claim 17, wherein the outlet end portion comprises at least first, second, and third outlet ports, the first outlet port being positioned to remove at least the at least one blocked blood component, one of the second and third outlets ports being positioned to remove at least the relatively low density blood component from the vessel, another of the second and third outlet ports being positioned to remove at least the relatively high density blood component from the vessel.

20. The device of claim 19, wherein an outlet of the filter is in flow communication with said one of the ports positioned to remove at least one relatively low density blood component so as to mix the at least one low density blood component with filtered substance flowing from the filter outlet.

21. The device of claim 17, wherein the outlet end portion comprises an outlet port positioned to adjust an interface of separated blood components in the vessel.

22. The device of claim 17, wherein the barrier is a skimmer dam extending across the outlet end portion.

23. The device of claim 17, wherein the separation vessel comprise a generally annular channel.

24. A centrifugal separation system comprising:
the device of claim 17; and
a centrifuge rotor configured to be rotated about an axis of rotation, wherein the centrifuge rotor comprises a retainer configured to retain the separation vessel.

25. The system of claim 24, further comprising a mount associated with the rotor, wherein the mount is configured to mount the filter to the rotor so that the filter rotates along with the rotor about the axis of rotation.

26. The system of claim 24, wherein the retainer comprises a generally annular groove in the rotor.

27. The system of claim 26, wherein the separation vessel comprise a generally annular channel configured to be placed in the groove.

28. The system of claim 27, wherein at least part of the separation vessel is formed of at least one of a semi-rigid material and a flexible material.

29. The system of claim 28, wherein the groove is defined by an inner wall spaced from the axis of rotation and an outer wall spaced farther from the axis of rotation than the inner wall, wherein the inner wall comprises a ridge extending toward the outer wall, the ridge deforming the separation vessel to form a trap dam in the separation vessel.

30. A method of separating blood components, comprising:
providing the device of claim 1;
placing the separation vessel in a retainer of a rotatable centrifuge rotor;
rotating the centrifuge rotor and the separation vessel about an axis of rotation of the centrifuge rotor;
introducing blood components into the separation vessel,
wherein the blood components form stratified layers in the separation vessel;
removing at least some blood components from the separation vessel via the first outlet port; and
filtering the removed blood components with the filter so as to filter at least some leukocytes from the removed blood components.

31. The method of claim 30, wherein the rotating further comprises rotating the filter about the axis of rotation.

32. The method of claim 31, wherein the filtering occurs during the rotation of the filter about the axis of rotation.

33. The method of claim 30, wherein a buffy coat layer of the blood components is formed in the separation vessel, and wherein the blood components removed via the first outlet port comprise platelets and leukocytes from the buffy coat layer.

34. The method of claim 30, wherein the blood components removed via the first outlet port are intermediate density blood components, and wherein the method further comprises removing plasma from the vessel via one of the second and third ports and removing red blood cells from the vessel via another of the second and third ports.

35. The method of claim 34, further comprising mixing plasma removed from the vessel with the filtered blood components.

36. The method of claim 30, further comprising controlling position of an interface between high and intermediate density blood components, wherein the controlling of the interface position comprises removing high and low density blood components from the separation vessel via an interface positioning port.

37. The method of claim 30, further comprising accumulating at least intermediate density blood components with a barrier in the separation vessel, the accumulated intermediate density blood components being removed from the separation vessel via the first outlet port.

38. The method of claim 37, further comprising flowing high and low density blood components past the barrier.

39. A method of separating blood components, comprising:
providing the device of claim 17;
placing the separation vessel in a retainer of a rotatable centrifuge rotor;
rotating the centrifuge rotor and the separation vessel about an axis of rotation of the centrifuge rotor;
introducing blood components into the separation vessel,
wherein the blood components form stratified layers in the separation vessel;
removing at least some blood components from the separation vessel via the at least one outlet port; and
filtering the removed blood components with the filter so as to filter at least some leukocytes from the removed blood components.

40. The method of claim 39, wherein the rotating further comprises rotating the filter about the axis of rotation.

41. The method of claim 40, wherein the filtering occurs during the rotation of the filter about the axis of rotation.

42. The method of claim 39, wherein a buffy coat layer of the blood components is formed in the separation vessel, and wherein the blood components removed via the at least one outlet port comprise platelets and leukocytes from the buffy coat layer.

43. The method of claim 39, wherein the blood components removed via the at least one outlet port are intermediate density blood components, and wherein the method further comprises removing plasma from the vessel and removing red blood cells from the vessel.

44. The method of claim 43, further comprising mixing plasma removed from the vessel with the filtered blood components.

45. The method of claim 39, further comprising controlling position of an interface between high and intermediate density blood components, wherein the controlling of the interface position comprises removing high and low density blood component from the separation vessel via an interface positioning port.

46. The method of claim 39, further comprising accumulating at least intermediate density blood components with the barrier in the separation vessel, the accumulated intermediate density blood components being removed from the separation vessel via the at least one outlet port, and wherein the method further comprises flowing plasma past the barrier via the first passage and flowing red blood cells past the barrier via the second passage.
